(19) United States
(12) Patent Application Publication
(10) Pub. No.: US 2004/0013819 A1
(43) Pub. Date: Jan. 22, 2004

(54) Oriented mesotubular and nantotubular non-wovens

(76) Inventors: Haoqing Hou, Akron, OH (US); Johannes Averdung, Gelsenkirchen (DE); Wolfgang Czado, Gefrees (DE); Andreas Greiner, Amoneburg (DE); Joachim H. Wendorff, Marburg (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/399,783

(22) PCT Filed: Oct. 9, 2001
(86) PCT No.: PCT/EP01/11661

(30) Foreign Application Priority Data
Oct. 26, 2000 (DE) 10053263.2

(51) Int. Cl. H05H 1/48

(52) U.S. Cl. 427/580

(57) ABSTRACT

The invention relates to oriented webs of meso- and nanotubes (hollow fibers) wherein the tubes or hollow fibers have an internal diameter of 10 nm to 50 μm and are preferentially oriented in one direction and to a process for their production.

The oriented hollow fiber webs can be produced by coating oriented template fiber webs of degradable materials with nondegradable materials by destroying the degradable materials by thermal methods for example.

The oriented template fiber webs of degradable materials can be produced by specific electrospinning techniques.

The oriented hollow fiber webs are useful for example in separation technology, catalysis, microelectronics, medical technology, construction materials technology or the clothing industry.

This invention relates to oriented webs of meso- and nanotubes, i.e., webs wherein the tubes or hollow fibers, which have an internal diameter in the nano- to micrometer range, are preferentially oriented in one direction, to processes for their production and to the use of these webs.

Webs are generally loose sheet materials comprising textile or nontextile spun or hollow fibers or filaments, whose cohesiveness is due to the tackiness intrinsic to the fibers.

Oriented webs (cf. DIN 61210, 1982, p. 2) are webs where the spun or hollow fibers or filaments are preferentially oriented in one direction.

Webs are known and find use, inter alia, for textile applications, for example for diapers and hygiene articles, protective clothing in the medical sector and clean room technology and also for the filtration of gases and liquids (see Kirk-Othmer, Encyclopedia of Chemical Technology, 4 Ed. Vol. 17, p. 303-368 and Ullmann's Encyclopedia of Industrial Chemistry, 5 Ed. Vol. A17, p. 565-587).

As used herein, “hollow fibers, mesotubes and nanotubes” are generally tubes having an internal diameter of below 0.1 mm.

Tubes or hollow fibers having a small internal diameter are known and are used in particular for separation purposes, for example in medical dialysis, for gas separation or osmosis of aqueous systems, for example for water treatment (see Kirk-Othmer, Encyclopedia of Chemical Technology, 4 Ed. Vol. 13, p. 312-313). The fiber material usually consists of polymers, which may in addition have pores, i.e., properties of semipermeable membranes. The hollow fibers uses for separation purposes usually have a surface area of 100 cm² per cm³ of volume coupled with an internal diameter of 75 μm to 1 mm.

A further application of hollow fibers is in microelectronics. Here, superconducting fibers about 60 μm in diameter are produced from superconducting material by filling hollow polymeric fibers with a material which, after thermodegradation of the polymer, possesses superconducting properties (J. C. W. Chien, H. Ringsdorf et al., Adv. Mater., 2 (1990) p. 305).

Tubes having a small internal diameter are generally produced by extrusion spinning processes; a number of extrusion spinning processes are described in Kirk-Othmer, Encyclopedia of Chemical Technology, 4. Ed. Vol. 13, p. 317-322.

Extrusion spinning processes provide hollow fibers having an internal diameter of down to 2 μm. The production of hollow fibers having smaller internal diameters is not possible by these processes.

Very thin fibers without internal cavity can be produced by electrostatic spinning, or electrospinning. In electrospinning, polymer melts or polymer solutions are extruded through cannulas under a low pressure in an electric field. The principles of this technique may be found in EP 0 005 035, EP 0 095 940, U.S. Pat. No. 5,024,789 or WO 91/01695 for example.

Using electrospinning to produce fibers having a small diameter results in the formation of webs of isotropically oriented individual fibers randomly distributed in any direction (L. Huang, R. A. McMillan et al., Macromolecules, 33, (2000), p. 2989-2997), Sharzad Zarkoob, Dareell H. Reneker et al., Polymer. Prep., 39 (1998), p. 244-245). Electrospinning provides solid fibers 10-3000 nm in diameter; but not hollow fibers.

Tubular products such as vascular implants having a sheath comprising a web of elastic nanofibers and tube diameters in the mm range can be generated by collecting electrospun fibers on a rotating mandrel (U.S. Pat. No. 5,024,789). In the case of this technique it is likewise observed that fibers having a diameter of not more than 1 μm are deposited with random orientation. Using a similar process to deposit electrospun poly-benzimidazole nanofibers on a rotating cylinder provides fiber webs whose strength in the winding direction indicates that more fibers are disposed in that direction. However, examination by scanning electron microscopy reveals that even such webs consist predominantly of randomly oriented, individual fibers (J. -S. Kim, D. H. Reneker, Polym. Eng. Sci., 39, (1999), p. 849-853).

U.S. Pat. No. 4,689,186 describes an electrospinning process for generating tubular products by using an auxiliary electrode to deposit a proportion of the fibers in the stretched state in circumferential disposition, so that upon removal of the rotating mandrel the tube diameter reduces because the extended fiber sheath contracts. The production of sheetlike oriented fiber webs is not possible by this technique, however.

Orientation for the purposes of the present invention relates to the attitude of one fiber in relation to the attitude of another fiber and not to the molecular orientation of the macromolecules within any one electrostatically spun fiber. Electrostatically spun fibers can be randomly oriented with respect to each other, notwithstanding their position of molecular orientation parallel to the fiber axis for example (C. J. Buchko, L. C. Chen et al., Polymer 40 (1999) p. 7397-7407).

The orientation of fibers in a planar arrangement can be described using the orientation parameter fₚ=[2<cos² Ø>−1] (S. H. McGee, R. L. McCullough, J. Appl. Phys. 55, 1984, p. 1394-14039). <cos² Ø> corresponds to

$$⟨ {cos}^{2} ∅ ⟩ = [ {\sum }_{j} N ( {∅}_{j} ) {cos}^{2} {∅}_{j} ] / {N}_{total}$$

The attitude of fibers is determined with respect to a given axis. Ø is the angle relative to this preferred axis. N is the number of fibers in the respective angle classes Øj and Nₜₒₜₐₗ is the total number of fibers measured.

The orientation parameter fₚ takes values between +1 and 0. fₚ=1 when all fibers have an orientation parallel to a preferred direction and =0 in the case of a random distribution.

Hollow fibers having a very small internal diameter have hitherto only been obtainable by electrochemical synthesis, as described in L. A. Chernozantonskii, Chem. Phys. Lett. 297, 257, (1998), by methods of supramolecular chemistry (S. Demoustier—Champagne et al., Europ. Polym. J. 34, 1767, (1998) or using self-organizing membranes as templates (E. Evans et al., Science, Vol 273, 1996, p. 933-995). Hollow carbon fibers based on fullerene chemistry (carbon nanotubes) having single- or multi-walled structures made of a single rolled-up graphite layer (layer of six-membered carbon rings fused to one another on all sides) or concentrically arranged graphite cylinders are described for example in “Fullerenes and Related Structures”, Ed. A. Hirsch, Springer Verlag 1999, p. 189-234 or N. Grobert, Nachr. Chem. Tech. Lab., 47, (1999), 768-776.

However, these methods can only be applied to specific materials and cannot be employed to produce industrially useful, i.e., mechanically and chemically- stable, hollow fibers.

There are many applications, for example the separation of gases, where it is advantageous to use hollow fibers having small external and/or internal diameters that are made of various materials matched to the respective area of application. In particular, the materials should be capable of withstanding thermal, mechanical and chemical loads, have a porous structure if need be, selectively be electrical conductors or insulators and consist of polymers, inorganics or metals. Corresponding hollow fibers having an internal diameter of 10 nm to 50 μm and made of industrially usable materials such as polymers, inorganics or even metals and a process for producing them are described in DE 10 23 456.9.

The hollow fibers described in DE 10 23 456.9 preferably have internal diameters of 50 nm to 20 μm, particularly preferably 100 nm to 5 μm, most preferably 100 nm to 2 μm or respectively 100 nm to 1 μm, 500 nm to 1 μm, 10 nm to 1 μm or 100 nm to 500 nm.

The length of the hollow fibers is determined by the intended use and is generally in the range from 50 μm to several mm or cm.

The wall thickness i.e., the thickness of the outer walls, of the hollow fibers is variable and is generally 10 to 5000 nm, preferably 10 to 1 000 nm, particularly preferably 10 to 250 nm.

Hollow fibers as described in DE 10 23 456.9, as well as the very small internal diameters, have a number of properties which make them useful in the areas of medicine, electronics, catalysis, chemical analysis, gas separation, osmosis or optics.

The outer walls of the hollow fibers according to the invention can be constructed of a very wide variety of materials, for example polymers, metals or metal-containing inorganic compounds. The outer walls may be one layer of these materials, i.e., be completely made thereof, or possess a plurality of layers of identical or different materials. The very small internal diameter ensures a very high ratio of surface area to volume for the hollow fibers.

The process for producing the hollow fibers as described in DE 10 23 456.9 can be practiced by coating a fiber of a first, degradable material with at least one coating of at least one further material and subsequently degrading the first material, with the proviso that the hollow fiber obtained in this way has an internal diameter of 10 nm to 50 μm.

One version of the process of DE 10 23 456.9 comprises initially coating a fiber of a first, degradable material. This fiber may comprise a material that is degradable thermally, chemically, radiation-chemically, physically, biologically, or using plasma, ultrasound or extraction with a solvent. These fibers may be produced using electrospinning technology.

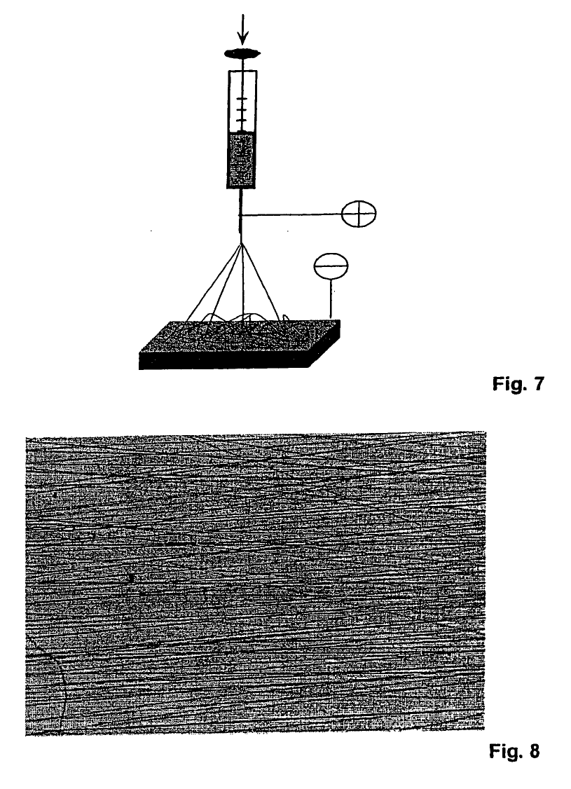

Details concerning electrospinning technology may be found for example in D. H. Reneker, I. Chun., Nanotechn. 7 216 (1996). The basic construction of an electrospinning apparatus is shown in FIG. 7.

The hollow fibers described in DE 10 23 456.9 form webs in which the hollow fibers assume any desired direction.

There are many applications, for example the separation of gases, where it would be desirable to use oriented hollow fiber webs in which the hollow fibers having small outer and/or internal diameters are preferentially oriented in one direction (straight-laid).

It is an object of the present invention to provide oriented hollow fiber webs comprising hollow fibers having an internal diameter in the nm to μm range.

The present invention accordingly provides hollow fiber webs as claimed in claim 1, comprising hollow fibers having an internal diameter of 10 nm to 50 μm and an outer wall constructed of metal-containing inorganic compounds, polymers and/or metals, wherein said hollow fibers forming said hollow fiber web are preferentially oriented in one direction.

The hollow fiber webs of the invention are very useful in separation, of gases for example, in catalytic systems and as a component of microreactors, since these webs comprise directed channels having a defined internal diameter.

The orientation of fibers in a planar arrangement can be described using the orientation parameter fₚ=[2<cos² Ø>−1] (S. H. McGee, R. L. McCullough, J. Appl. Phys. 55, 1984, p. 1394-14039). <cos² Ø> corresponds to

$$⟨ {cos}^{2} ∅ ⟩ = [ {\sum }_{j} N ( {∅}_{j} ) {cos}^{2} {∅}_{j} ] / {N}_{total}$$

The attitude of fibers is determined with respect to a given axis. Ø is the angle relative to this preferred axis. N is the number of fibers in the respective angle classes Øj and Nₜₒₜₐₗ is the total number of fibers measured.

The orientation parameter fₚ takes values between +1 and 0. fₚ=1 when all fibers have an orientation parallel to a preferred direction and =0 in the case of a random distribution.

The hollow fiber webs of the invention preferably have an orientation parameter fₚ of 0.2 to 1, particularly preferably 0.5 to 1, most preferably of 0.6 to 1, 0.7 to 1, 0.8 to 1, 0.9 to 1 or 0.6 to 0.9.

The orientation parameter may also be characterized by a standard deviation [°] of the attitude of the fibers in relation to a preferred direction. Disorder, i.e., any random orientation, exists when the standard deviation is about 52. In the ideal case, when all the fibers have the same orientation, the standard deviation is 0.

The hollow fibers of the oriented hollow fiber webs according to the invention preferably have internal diameters of 50 nm to 20 μm, particularly preferably 100 nm to 5 μm, most preferably 100 nm to 2 μm, or respectively 100 nm to 1 μm, 500 nm to 1 μm, 10 nm to 1 μm or 100 nm to 500 nm.

The length of the hollow fibers is determined by the intended use and is generally in the range from 50 μm to several mm or cm.

The wall thickness i.e., the thickness of the outer walls, of the hollow fibers is variable and is generally 10 to 5 000 nm, preferably 10 to 1 000 nm, particularly preferably 10 to 250 nm.

The present invention further provides a process for producing the oriented hollow fiber webs as is claimed in claim 10.

The process for producing the oriented hollow fiber webs of the invention may comprise first generating a web of preferentially unidirectionally oriented fibers of a first degradable material, coating said oriented fiber web with at least one coating of at least one further material and subsequently degrading said first material with the proviso that the hollow fibers of the resultant hollow fiber web are preferentially oriented in one direction and have an internal diameter of 10 nm-50 μm.

The preferentially unidirectionally oriented fibers of the fiber web of a first degradable material may comprise a material that is degradable thermally, chemically, radiation-chemically, physically, biologically, or using plasma, ultrasound, microwaves or extraction with a solvent.

These oriented fiber webs of a first, degradable material are surprisingly producible using known electrospinning technology where a polymer solution or melt is spun in a high voltage field between a spinneret and a counterelectrode (FIG. 7). Further details concerning electrospinning technology may be found for example in D. H. Reneker, I. Chun., Nanotechn. 7 216 (1996).

In a particularly preferred embodiment of the process according to the invention, a frame, right-angled for example, of a conductive material is introduced into the space between spinneret and counterelectrode (FIG. 1) to collect the fibers. It is believed that the process provides orientation according to the following mechanism. The fibers are first deposited on some part of the frame. Since, as a result, the fibers insulate the area of deposition, the charge carried by the fibers cannot drain away, a repellent charge concentration builds up in this area and the polymer solution jet from which the fibers issue jumps to some other part of the frame. In the process, the fibers come to be linearly disposed between the jump-off areas. The new area of deposition of the jet again undergoes insulation with a subsequent charge buildup, so that the jet jumps again. This process repeats continuously and leads to a linear deposition of the fibers between the frame members, so that the fibers are preferentially oriented in one direction.

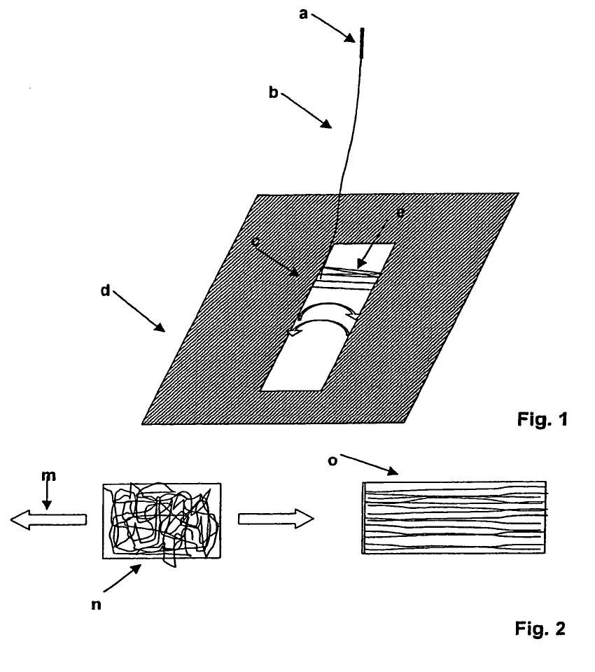

A further variant comprises first producing a fiber web of a first, degradable material using the electrospinning technique described in DE 10 23 456.9. The randomly oriented fibers of the disordered fiber web can subsequently be preferentially aligned in one direction by drawing, so that an oriented fiber web is obtained (FIG. 2).

It is further possible to produce oriented fiber webs by electrospinning by depositing the fibers of a first degradable material on a conductive rotating drum counterelectrode to which high voltage is applied. It depends on the diameter and frequency of rotation of the drum whether the fibers are deposited with random orientation or with preferential orientation in one direction (FIG. 3).

Oriented fiber webs can also be generated by electrospinning using mechanically or electrically generated high voltage alternating fields.

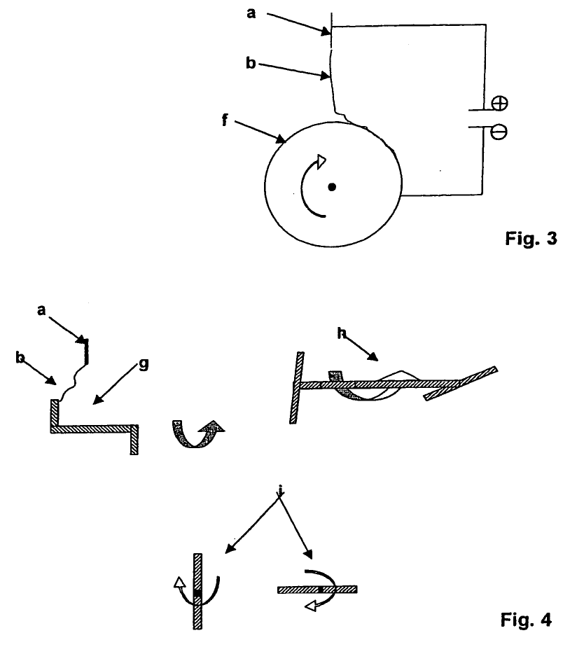

In one variant, the fibers are deposited on a rotating hook-shaped electrode (FIG. 4) while linearly oriented between the rotating hooks in a preferred direction. Since the electric field is strongest between the electrode part nearest the spinneret, this field maximum constantly jumps between the left and right hooks as the electrode rotates. The frequency is adjustable via the speed of rotation. Since the jet follows the field maximum, the fibers are laid down between the electrodes. Instead of a hook electrode it is also advantageous to use double hook electrodes or two synchronously turning rod electrodes (FIG. 4).

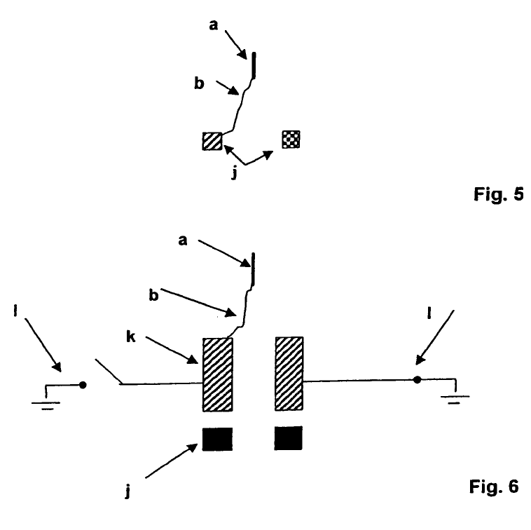

In a further variant, the electrospinning process is carried out using a high alternating voltage applied to two counterelectrodes to continuously alternate the electric field between the electrodes and thus also the jet, which can only arise in a strong electric field and follows same (FIG. 5). The fibers are linearly deposited between the electrodes with a preferential orientation. Typically the difference in potential between the counterelectrodes is of a similar order of magnitude as the difference in potential between spinneret and counterelectrodes, since otherwise fibers will be deposited simultaneously on both counterelectrodes.

It is further possible to deposit fibers linearly and oriented in a preferential direction by using a small difference in potential, for example a difference of 200 V, between two counterelectrodes by alternatingly disconnecting the counterelectrodes to respectively cancel the grounding. The field collapses at whichever is the ungrounded counterelectrode, so that fibers are deposited only on the grounded counterelectrode. Alternating selection of the electrodes provides linear deposition of oriented fibers between the counterelectrodes. In one variant, the potential of both the counterelectrodes is reduced to 0 and the counterelectrodes are alternately grounded and disconnected. The fibers are likewise laid down linearly between the electrodes and an oriented fiber web is obtained.

Oriented fiber webs can further be generated by electrospinning with two interelectrodes, typically metal rods, placed in the space between spinneret and counterelectrode and alternatingly grounded (FIG. 6). Interelectrodes placed in the space between spinneret and counterelectrode transmit the voltage of the counter-electrode by influence; owing to the smaller distance between spinneret and interelectrode, the electric field is stronger than the electric field without inter-electrodes between spinneret and counterelectrode. When an interelectrode is grounded, it will be left with only 0 V applied to it and the field between spinneret and inter-electrode weakens. Alternatingly grounding the inter-electrodes, then, provides for linear laydown of the fibers between the electrodes with preferential orientation, and an oriented fiber web is obtained.

The diameter of the degradable fibers of the preferentially unidirectionally oriented fiber web should be of the same order of magnitude as the later desired internal diameter of the hollow fibers of the oriented hollow fiber web. In general, the later internal diameter of the hollow fibers of the oriented hollow fiber web is of approximately the same size as the diameter of the degradable fibers or coatings. The precise dimensions depend on the materials used and their changes during the degradation process and can be determined without difficulty by preliminary experimentation.

Degradable fiber materials may be organic or inorganic materials, especially polymers such as polyesters, polyethers, polyolefins, polycarbonates, polyurethanes, natural polymers, polylactides, polyglycosides, polyamides, polyvinyl alcohols, poly-α-methylstyrene, polymethacrylates and/or polyacrylonitriles.

The coating with at least one further nondegradable material can be effected by gas phase deposition, plasma polymerization or by applying the material in a melt or solution. The coating can be effected in various layers and with various materials and forms the outer wall of the hollow fibers of the hollow fiber web according to the invention.

This coating, i.e., the construction of the outer walls of the hollow fibers of the hollow fiber web according to the invention, can be effected for example by gas phase deposition, knife coating, spin coating, dip coating, spraying or plasma deposition of polymers such as poly(p-xylylene), polyacrylamide, polyimides, polyesters, polyolefins, polycarbonates, polyamides, polyethers, polyphenylene, polysilanes, polysiloxanes, poly-benzimidazoles, polybenzothiazoles, polyoxazoles, polysulfides, polyester amides, polyarylenevinylenes, polylactides, polyether ketones, polyurethanes, polysulfones, Ormocers, polyacrylates, silicones, wholly aromatic copolyesters, poly-N-vinylpyrrolidone, polyhydroxyethyl methacrylate, polymethyl methacrylate, polyethylene terephthalate, polybutylene terephthalate, polymethacrylonitrile, polyacrylonitrile, polyvinyl acetate, neoprene, Buna N, polybutadiene, polytetrafluoroethene, cellulose (modified or unmodified), □-olefins, alginates or collagen, homopolymers, copolymers and/or blends thereof.

The degradable fibers may further be coated with a further material obtained by polymerization of one or more monomers. Useful monomers for homo- or copolymerization are for example methacrylate, styrenesulfonate, 1,6-hexamethylene diisocyanate(HDI), 4,4′-methylenebiscyclohexyl diisocyanate(HMDI), 4,4′-methylenebis(benzyl diisocyanate)(MDI), 1,4-butanediol, ethylenediamine, ethylene, styrene, butadiene, 1-butene, 2-butene, vinyl alcohol, acrylonitrile, methyl methacrylate, vinyl chloride, fluorinated ethylenes or terephthalate.

The coating, i.e., the construction of the outer walls of the hollow fibers of the oriented hollow fiber web, may comprise metals of groups Ia, Ib, IIa, IIb, IIIa, IIIb, IVa, IVb, Vb, VIb, VIIb and/or VIIIb of the Periodic Table, in each case as a pure metal or as an alloy. Useful metals include for example gold, palladium, aluminum, platinum, silver, titanium, cobalt, ruthenium, rhodium, sodium, potassium, calcium, lithium, vanadium, nickel, tungsten, chromium, manganese and/or silicon. The coating can be effected by vapor deposition with the metals or by decomposition of suitable organometallic compounds using CVD methods.

Polymeric coating materials may further bear functional groups, such as esters, amides, amines, silyl groups, siloxane groups, thiols, hydroxyl groups, urethane groups, carbamate groups, nitrile groups, C═C groups, C≡C groups, carbonyl halide groups, sulfoxide groups, sulfone groups, pyridyl groups, arylphosphine groups or else ionic groups such as carboxylic acids, sulfonic acids or quaternary amines. The functional groups can be applied to the inner and/or outer surface of the hollow fibers of the hollow fiber web according to the invention and improve the surface properties of the hollow fibers in separation or osmosis processes. The functional groups may also be chemically modified subsequently by polymer-analogous reactions, (for example hydrolysis of esters).

Judicious functionalization also makes it possible for active substances such as antibiotics, anesthetics, proteins such as insulin, antifouling agents, agrochemicals such as herbicides or fungicides to be reversibly immobilized in the hollow fibers and/or released again at a controlled or slow rate.

The outer wall of the hollow fibers of the hollow fiber web according to the invention, i.e., the nondegradable further material, may also be constructed of glass, glass-ceramics, SiOₓ, perovskite, ceramics, aluminum oxides or zirconium oxides, optionally of silicon carbide, boron nitride, carbon and also metal oxides. Suitable methods here are likewise gas phase deposition processes (CVD or PVD) or hydrothermal processes.

Useful perovskites have the general formula

LaXYMgO

where X═Ca, Sr, Ba

Y═Ga, Al

(without stoichiometry) and have oxygen ion-conducting properties.

The degradation of the degradable material can be effected thermally, chemically, radiation-inducedly, biologically, photochemically, using plasma, ultrasound, hydrolysis or by extraction with a solvent. Thermal degradation has proven successful in practice. The decomposition conditions are, depending on the material, 100-500° C. and 0.001 mbar to 1 bar, particularly preferably 0.001 to 0.1 mbar. Degradation of the material provides a hollow fiber whose wall material consists of the coating materials.

It is also possible for a plurality of layers of different materials to be applied to the fibers of the oriented fiber web. This provides oriented hollow fiber webs comprising hollow fibers having different inner and outer walls, or the outer walls of the hollow fibers can be constructed of a plurality of layers. The different layers can perform different functions; for instance, the inner layer can have particular separation properties, for example for chromatographic purposes, and the outer layer can have high mechanical stability.

The following layer sequences for the hollow fibers of the oriented hollow fiber webs of the invention may be mentioned by way of example:

glass/metal

metal/glass

glass/polymer

polymer/glass

polymer/polymer

metal/metal

metal-containing inorganic compound/metal-containing inorganic compound

ceramic/ceramic

polymer/metal

metal/polymer

ceramic/polymer

polymer/ceramic

metal/ceramic

ceramic/metal

polymer/metal/polymer

metal/polymer/metal

metal/ceramic/metal

polymer/ceramic/polymer

ceramic/polymer/ceramic

polymer/glass/polymer

glass/polymer/glass

Oriented hollow fiber webs according to the invention are useful in particular as a separation or storage medium for gases, liquids or particle suspensions and for filtering or purifying compositions of matter. Possible applications are as a membrane for gases, especially H₂ or liquids, for particle filtration, in chromatography, for oil/water separation, as an ion exchanger in dialysis, for size separation of cells, bacteria or viruses, as a constituent of an artificial lung, for desalination, for drainage or irrigation or as a filter for dewatering power fuels.

Oriented hollow fiber webs according to the invention may further be used in sensor technology for solvent, gas, moisture or biosensors, in capillary electrophoresis, in catalytic systems or as materials of construction in superlightweight building construction, as a mechanical reinforcement similar to glass fibers, as a noise or vibration abater, as a composite material, as a filler, as a controlled release or drug delivery system, in medical separation technologies, in dialysis, as an artificial lung, as a protein store or in tissue engineering.

The oriented hollow fiber webs of the invention may be used in the clothing/textile industry as a thermal insulator in clothing or sleeping bags, in photo- or thermochromic clothing through embedding of dyes in the tube interior or as an authenticator through markers in the tube interior.

Hollow fiber webs according to the invention also find use in electronics, optics or energy production. The oriented hollow fibers of the hollow fiber webs can be used to produce wires, cables or capacitors, micro-machines (for example for piezoelectric shaping, nanoperistaltic pumps or for shaping photoadressable polymers) or interlayer dielectrics. Further uses for hollow fiber webs according to the invention are microreactors, for example for catalytic reactions, template reactions and bioreactors, heat generation through conversion of sunlight (solar α systems) or in chip technology as flexible devices.

Depending on the materials used for forming the hollow fiber, the hollow fiber webs of the invention can have a very low dielectric constant and can therefore in this case also be used as a dielectric, especially as an interlayer dielectric in electronic components, for example in chip manufacture. Interlayer dielectrics having a low dielectric constant are important in the production of new chip generations having even smaller dimensions or higher storage densities. Owing to the high proportion of included air per unit volume, the hollow fibers of the invention have a dielectric constant of less than 4, preferably less than 3, most preferably less than 2, ideally less than 1.5.

Owing to the large surface area of the hollow fibers of the hollow fiber webs according to the invention, these can also be used in fuel cells, batteries or electrochemical reactions. For such uses, the outer wall of the hollow fibers of the oriented hollow fiber webs advantageously consists of oxygen ion conductors, for example perovskites. In oxidation reactions, the hollow fibers may be surrounded by the reactant, an olefin for example, while oxygen is passed through the cavities of the fibers. The oxidation product is formed on the outside of the hollow fibers and transported away.

The oriented hollow fiber webs of the invention can be used as a catalytic system. It is thus possible for example to use oriented hollow fiber webs of noble metals such as platinum or palladium as denoxing catalysts or oriented hollow fiber webs comprising noble metals, such as platinum and/or palladium, in motor vehicles.

Individual oriented hollow fiber webs according to the invention may be cross-laid to form cross-laid webs in which the hollow fibers are preferentially oriented in two directions and which are useful for example in microreaction technology as miniaturized heat exchangers or for gas separation.

The examples which follow illustrate the invention in a nonlimiting manner.

### EXAMPL 1

Production of an Oriented Polylactide Template Fiber Web by Deposition on a Frame

A 6.3% solution of poly-L-lactide in dichloromethane was electrospun in the apparatus of FIG. 7 on a right-angled aluminum frame (25 cm in frame length 6.5 cm in width) disposed in the space between spinneret (+12 kV) and counterelectrode (−35 kV) at a voltage of . . . and a flow rate of 1 ml/min. The separation of the cannula tip (diameter 0.3 mm) from the aluminum frame was 10 cm. The oriented polylactide fiber web was further used without further treatment. An optical photomicrograph of the preferentially linearly unidirectionally oriented fibers of the fiber web is shown in FIG. 8.

### EXAMPLE 2

Production of an Oriented Polylactide Template Fiber Web by Drawing

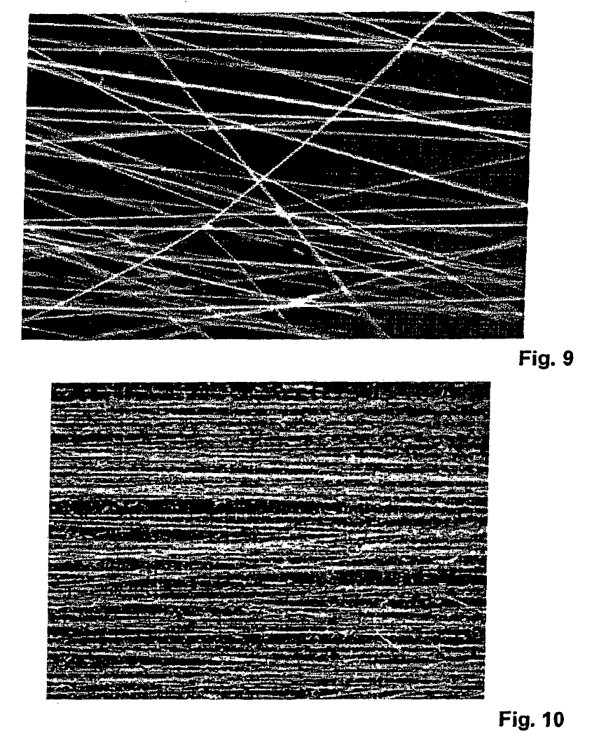

A 6.3% solution of poly-L-lactide in dichloromethane was electrospun at a voltage of 35 kV in the apparatus of FIG. 1. The separation of the cannula tip (diameter 0.3 mm) from the substrate plate (glass) was 10 cm. The polylactide fibers were subsequently oriented by extending the fiber web by 75% of its original length along one axis (FIG. 2). The oriented polylactide fiber web was further used without further treatment. An optical photomicrograph of the fibers is shown in FIG. 9.

### EXAMPLE 3

Production of an Oriented Polylactide Template Fiber Web by Deposition of the Fibers on a Rotating Drum Electrode

A 5% solution of poly-L-lactide was electrospun in the apparatus of FIG. 3 using a voltage of +15 kV at the cannula tip and −0 kV at the drum (counterelectrode) and a rotary frequency of 10 Hz. The separation of the cannula tip (diameter 0.3 mm) from the drum was 10 cm. The drum was 10 cm in diameter and 7 cm in width. An optical photomicrograph of the fibers of the oriented polylactide fiber web is shown in FIG. 10.

### EXAMPLE 4

Production of an Oriented Polylactide Template Fiber Web by Deposition of the Fibers Using Changing High Voltage Fields

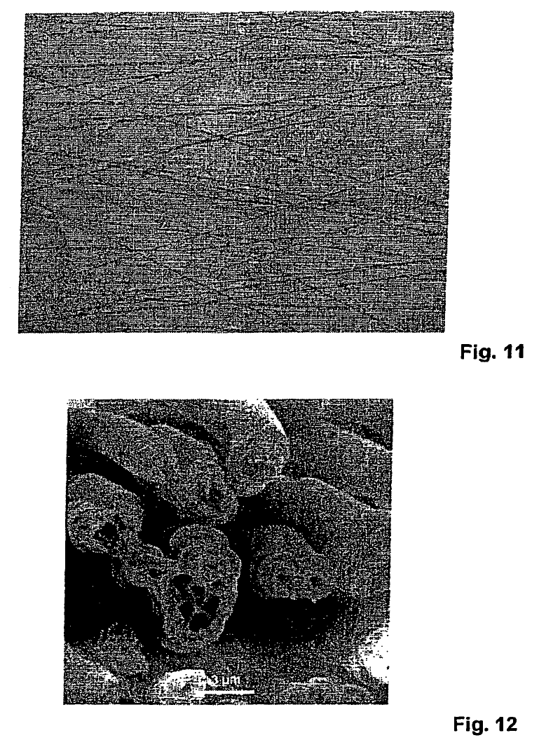

A 5% solution of poly-L-lactide was electrospun in the apparatus of FIG. 6 using a voltage of +15 kV at the cannula tip, −10 kV at the counterelectrodes and 0 kV at the interelectrodes. The separation of the cannula tip (diameter 0.3 mm) from the interelectrodes (round brass disk 10 cm in diameter and 1 cm in thickness, with a brass tube 1 cm in diameter and 15 cm in length placed centrally on top) was 15 cm. The separation of the interelectrodes was 10 cm and the separation of the interelectrodes from the counterelectrodes (brass disks 5 cm in diameter and 1 cm in thickness) was 3 cm. An optical photomicrograph of the fibers of the preferentially oriented polylactide fiber web is shown in FIG. 11.

### EXAMPLE 5

Production of Oriented poly-p-xylylene/Gold Composite Hollow Fiber Webs

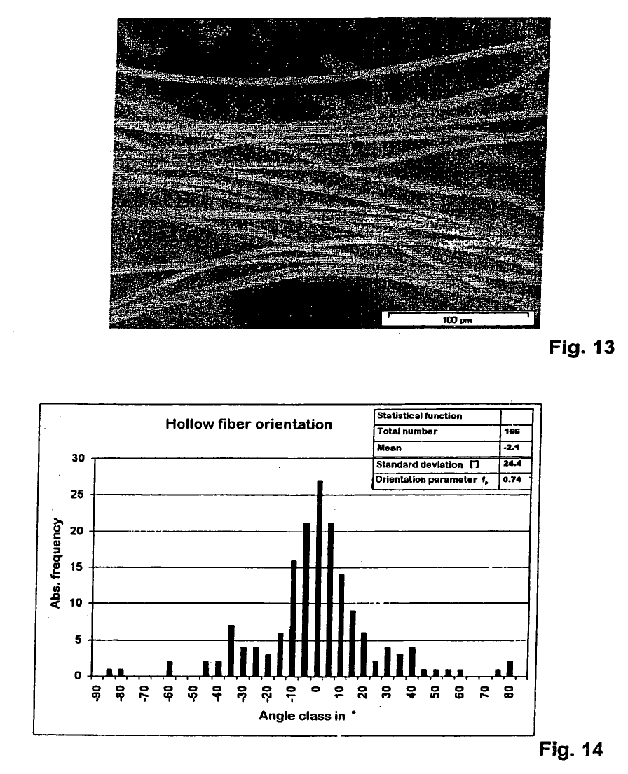

Polylactide template fiber webs produced by electro-spinning on an aluminum frame as described in Example 1 were coated with gold to a thickness of 100 nm from the gas phase in a vapor deposition apparatus. 700 mg of analytically pure [2.2]paracyclophane were subsequently vaporized at 180° C./0.1 mbar in a gas deposition apparatus and pyrrolyzed at 580° C., causing the formation of a poly(p-xylylene) layer (PPX) on the composite fiber web in the sample chamber at about 20° C. The polylactide of the poly(p-xylylene)/gold/polylactide composite web was subsequently removed by pyrrolysis at 365° C./0.01 mbar. The formation of poly(p-xylylene)/gold composite hollow fibers having an internal diameter of about 1.2 μm-0.5 μm was confirmed by scanning electron microscopy (FIG. 12). The presence of the gold coating on the inner wall of the poly(p-xylylene) hollow fibers was verified by element-specific scanning electron microscopy. The orientation of the poly(p-xylylene/gold hollow fibers in the hollow fiber web preferentially in one direction was verified by optical microscopy (FIG. 13) and the determination of the orientation parameter fₚ=0.74 (FIG. 14). The orientation is also characterized by the standard deviation [°] It was 24.4 for this example.

### EXAMPLE 6

Production of an Oriented poly-(p-xylylene)/Polylactide Fiber Web by Coating Oriented Polylactide Template Fiber Webs from the Gas Phase

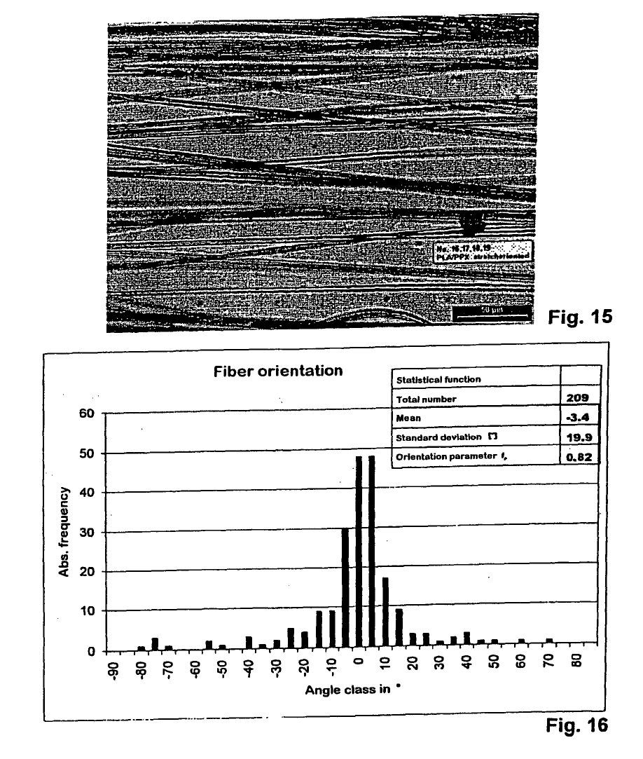

An oriented polylactide template fiber web produced by electrospinning and subsequent drawing as described in Example 2 was placed in the sample space of a gas phase deposition apparatus. 700 mg of analytically pure [2.2]paracyclophane was subsequently vaporized at 180° C./0.1 mbar and pyrrolyzed at 580° C., causing poly(p-xylylene) to form in the sample space at about 20° C. The orientation parameter of the poly(p-xylylene)/polylactide composite fiber web was verified by optical microscopy and the determination of the orientation parameter fₚ=0.82 (FIGS. 15 and 16). The orientation is also characterized by the standard deviation [°]. It was 19.9 for this example.

### EXAMPLE 7

Production of an Oriented poly-(p-xylylene)/Polylactide Fiber Web by Coating Oriented Polylactide Template Fiber Webs from the Gas Phase

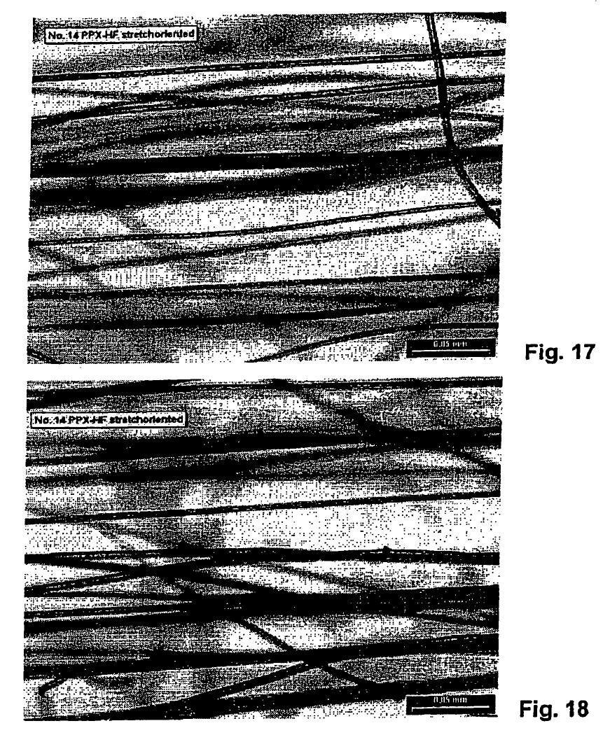

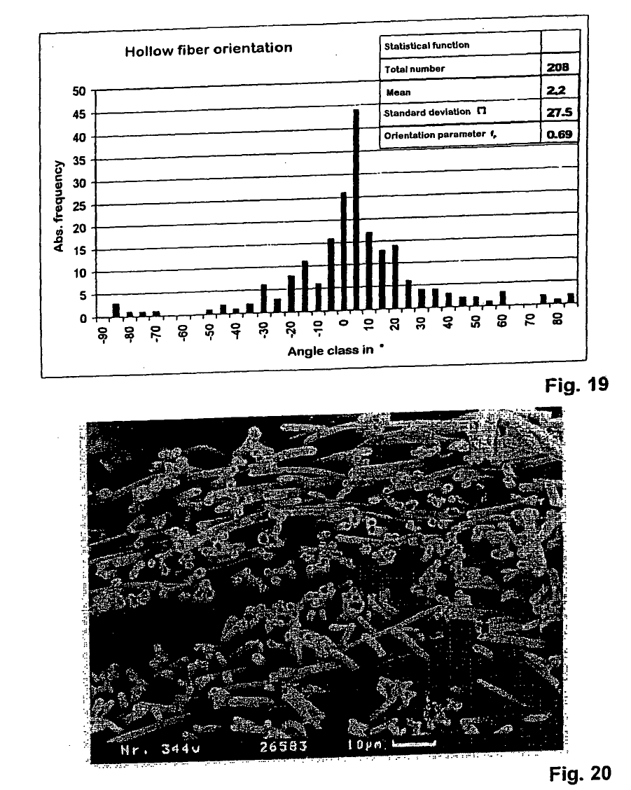

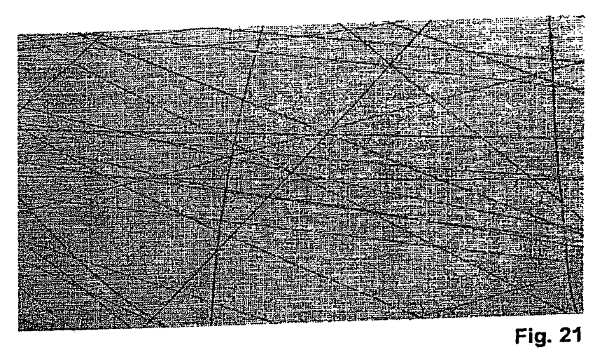

An oriented polylactide template fiber web produced by electrospinning and subsequent drawing as described in Example 2 was placed in the sample space of a gas phase deposition apparatus. 700 mg of analytically pure [2.2]paracyclophane was subsequently vaporized at 180° C./0.1 mbar and pyrrolyzed at 580° C., causing poly(p-xylylene) to form in the sample space at about 20° C. The polylactide of the poly(p-xylylene)/polylactide composite web was subsequently removed by pyrrolysis at 365° C./0.01 mbar. The orientation of the hollow fibers of the poly(p-xylylene) hollow fiber web in a preferential direction was verified by optical microscopy (FIGS. 17 and 18) and the determination of the orientation parameter fₚ=0.69 (FIG. 19). The formation of poly(p-xylylene) hollow fibers having an internal diameter of about 1.5 μm−0.3 μm was confirmed by scanning electron microscopy (FIG. 20). The orientation is also characterized by the standard deviation [°]. It was 27.5 for this example.

### EXAMPLE 8

Production of an Oriented poly(p-xylylene) Hollow Fiber Web on the Basis of an Oriented Template Fiber Web Generated Using Mechanically Generated High Voltage Alternating Fields

A 5% solution of poly-L-lactide was electrospun in the apparatus of FIG. 7 using a hook-shaped counter-electrode rotating about its longitudinal axis (FIG. 3c) and a voltage of +15 kV at the cannula tip and −10 kV at the hook electrode. The separation of the cannula tip (diameter 0.3 mm) from the hook electrode was 15 cm. The hooks of the counterelectrode were 0.5 cm in width, 5 in height and 0.1 cm in thickness, and the separation of hook from hook was 15 cm. An optical photomicrograph of the fibers of the preferentially oriented polylactide fiber web is shown in FIG. 21. The oriented polylactide template fiber web was placed in the sample space of a gas phase deposition apparatus. 550 mg of analytically pure [2.2]paracyclophane was subsequently vaporized at 180° C./0.1 mbar and pyrrolyzed at 580° C., causing the formation of poly(p-xylylene) in the sample space at about 20° C. The polylactide of the poly(p-xylylene)/polylactide composite web was subsequently removed by pyrrolysis at 365° C./0.01 mbar. The orientation parameter fₚ of the oriented poly(p-xylylene) hollow fiber web, determined on the basis of an optical photomicrograph, was 0.36. The orientation is also characterized by the standard deviation [°]. It was 41 for this example.

### LEGEND TO TH FIGUR S:

FIG. 1 Schematic representation of an electrospinning apparatus comprising frame disposed between spinneret and counterelectrode, with a) spinneret, b) jet, c) frame, d) counterelectrode, e) as-spun fibers

FIG. 2 Schematic representation of the production of oriented fiber webs by drawing, with m) direction of drawing, n) randomly ordered fiber web, o) oriented fiber web

FIG. 3 Schematic representation of an electrospinning apparatus comprising a rotating drum counter-electrode, with a) spinneret, b) jet, f) drum (counterelectrode)

FIG. 4 Schematic representation of an electrospinning apparatus comprising rotating electrodes, with a) spinneret, b) jet, g) hook electrode, h) double hook electrode, i) rod electrodes

FIG. 5 Schematic representation of an electrospinning apparatus comprising alternatingly connected counterelectrodes, with a) spinneret, b) jet, j) counterelectrodes

FIG. 6 Schematic representation of an electrospinning apparatus comprising interelectrodes, with a) spinneret, b) jet, k) interelectrodes, I) switch, j) counterelectrodes

FIG. 7 Schematic representation of an electrospinning apparatus

FIG. 8 Polylactide template-fibers of an oriented polylactide template fiber web produced by electrospinning from dichloromethane using a frame disposed between spinneret and counter-electrode (Example 1)

FIG. 9 Polylactide template fibers of an oriented polylactide template fiber web produced by electrospinning from dichloromethane and subsequent stretching (Example 2)

FIG. 10 Polylactide template fibers of an oriented polylactide template fiber web produced by electrospinning from dicholoromethane using a rotating drum (Example 3)

FIG. 11 Polylactide template fibers of an oriented polylactide template fiber web produced by electrospinning from dicholoromethane using alternating high voltage (Example 4)

FIG. 12 Scanning electron photomicrograph of poly(p-xylylene)/gold hollow fibers of an oriented poly(p-xylylene)/gold composite hollow fiber web after removal of polylactide template fibers (Example 5)

FIG. 13 Optical photomicrograph of poly (p-xylylene)/gold hollow fibers of an oriented poly(p-xylylene)/gold composite hollow fiber web after removal of polylactide template fibers (Example 5)

FIG. 14 Representation of result (diagram) of determination of orientation parameter fₚ of an oriented poly(p-xylylene)/gold composite hollow fiber web after removal of polylactide template fibers (Example 5)

FIG. 15 Optical photomicrograph of poly(p-xylylene)/polylactide fibers of an oriented poly(p-xylylene)/polylactide fiber web (Example 6)

FIG. 16 Representation of result (diagram) of determination of orientation parameter fₚ of an oriented poly(p-xylylene)/polylactide fiber web (Example 6)

FIG. 17 Optical photomicrograph of poly(p-xylylene) hollow fibers of an oriented poly(p-xylylene) hollow fiber web after removal of polylactide template fibers (Example 7)

FIG. 18 Optical photomicrograph of poly(p-xylylene) hollow fibers of an oriented poly(p-xylylene) hollow fiber web after removal of polylactide template fibers (Example 7)

FIG. 19 Representation of result (diagram) of determination of orientation parameter fₚ of an oriented poly(p-xylylene) hollow fiber web after removal of polylactide template fibers (Example 7)

FIG. 20 Scanning electron photomicrograph of poly(p-xylylene) hollow fibers of an oriented poly(p-xylylene) hollow fiber web after removal of polylactide template fibers (Example 7)

FIG. 21 Polylactide template fibers of an oriented polylactide template fiber web by electrospinning from dichloromethane using alternating high voltage (Example 4)

What is claimed is:

1. A hollow fiber web comprising hollow fibers having an internal diameter of 10 nm to 50 μm and an outer wall constructed of metal-containing inorganic compounds, polymers and/or metals, wherein said hollow fibers forming said hollow fiber web are preferentially oriented in one direction.

2. The hollow fiber web of claim 1 wherein said oriented hollow fibers have an orientation parameter fₚ of 0.2 to 1.

3. The hollow fiber web of claim 2 wherein said orientation parameter fₚ is 0.5 to 1.

4. The hollow fiber web of at least one of claims 1 to 3 wherein said internal diameter of said hollow fibers is 10 nm to 1 μm.

5. The hollow fiber web of at least one of claims 1 to 4 wherein said outer wall of said hollow fibers is constructed of poly(p-xylylene), polyacrylamide, polyimides, polyesters, polyolefins, polycarbonates, polyamides, polyethers, polyphenylene, polysilanes, polysiloxanes, polybenzimidazoles, polybenzothiazoles, polyoxazoles, polysulfides, polyester amides, polyarylenevinylenes, polylactides, polyether ketones, polyurethanes, polysulfones, Ormocers, polyacrylates, silicones, wholly aromatic copolyesters, poly-N-vinylpyrrolidone, polyhydroxyethyl methacrylate, polymethyl methacrylate, polyethylene terephthalate, polybutylene terephthalate, polymethacrylonitrile, polyacrylonitrile, polyvinyl acetate, neoprene, Buna N, polybutadiene, polytetrafluoroethene, cellulose (modified or unmodified), alginates or collagen, homopolymers, copolymers and/or blends thereof.

6. The hollow fiber web of at least one of claims 1 to 4 wherein the outer wall of the hollow fibers is constructed of metals from groups Ia, Ib, IIa, IIb, IIIa, IIIb, IVa, IVb, Vb, VIb, VIIb and/or VIIb of the Periodic Table, in each case as a pure metal or as an alloy.

7. The hollow fiber web of at least one of claims 1 to 4 wherein the outer wall of the hollow fibers is constructed of glass, glass-ceramics, SiOₓ, perovskite, ceramics, aluminum oxides or zirconium oxides.

8. The hollow fiber web of at least one of claims 1 to 7 wherein the outer wall of the hollow fibers is constructed of a plurality of layers.

9. The hollow fiber web of at least one of claims 1 to 4 having a dielectric constant of less than 4.

10. A process for producing oriented hollow fiber webs, which comprises first generating a web of preferentially unidirectionally oriented fibers of a first degradable material, coating said oriented fiber web with at least one coating of at least one further material and subsequently degrading said first material with the proviso that the hollow fibers of the resultant hollow fiber web are preferentially oriented in one direction and have an internal diameter of 10 nm-50 μm.

11. The process of claim 10 wherein said generating is effected by electrospinning said fibers onto a frame of a conductive material disposed in the space between spinneret and counterelectrode.

12. The process of claim 11 wherein said frame of conductive material is right angled.

13. The process of claim 10 wherein said generating is effected by first electrospinning a fiber web from a first degradable material and then preferentially aligning said fibers in one direction by drawing.

14. The process of claim 10 wherein said generating is effected by depositing said fibers of a first degradable material on a conductive rotating drum counterelectrode.

15. The process of claim 10 wherein said generating is effected by electrospinning using a high voltage alternating field.

16. The process of claim 15 wherein said high voltage alternating field is generated mechanically.

17. The process of claim 16 wherein said high voltage alternating field is generated using a rotating hook electrode.

18. The process of claim 16 wherein said high voltage alternating field is generated using a rotating double hook electrode.

19. The process of claim 16 wherein said high voltage alternating field is generated using two synchronously turning rod electrodes.

20. The process of claim 15 wherein said high voltage alternating field is generated electrically.

21. The process of claim 20 wherein said high voltage alternating field is generated using a high alternating voltage at two counterelectrodes.

22. The process of claim 20 wherein said high voltage alternating field is generated by using a small potential difference between two counterelectrodes and reciprocally canceling the grounding.

23. The process of claim 20 wherein said high voltage alternating field is generated between two counterelectrodes by applying a potential of 0 V to said counterelectrodes and reciprocally grounding and disconnecting.

24. The process of claim 20 wherein said high voltage alternating field is generated using two alternatingly earthed interelectrodes.

25. The process of at least one of claims 10 to 24 wherein said further material is constructed of inorganic compounds, polymers and/or metals.

26. The process of any of claims 10 to 25 wherein said further material comprises poly(p-xylylene), polyacrylamide, polyimides, polyesters, polyolefins, polycarbonates, polyamides, polyethers, polyphenylene, polysilanes, polysiloxanes, polybenzimidazoles, polybenzothiazoles, polyoxazoles, polysulfides, polyester amides, polyarylenevinylenes, polylactides, polyether ketones, polyurethanes, polysulfones, Ormocers, polyacrylates, silicones, wholly aromatic copolyesters, poly-N-vinylpyrrolidone, poly-hydroxyethyl methacrylate, polymethyl methacrylate, polyethylene terephthalate, polybutylene terephthalate, polymethacrylonitrile, polyacrylonitrile, polyvinyl acetate, neoprene, Buna N, polybutadiene, polytetrafluoroethene, cellulose (modified or unmodified), alginates or collagen, homopolymers, copolymers and/or blends thereof.

27. The process of any of claims 10 to 25 wherein said further material comprises metals of groups Ia, Ib, IIa, IIb, IIIa, IIIb, IVa, IVb, Vb, VIb, VIIb and/or VIIIb of the Periodic Table, in each case as a pure metal or as an alloy.

28. The process of any of claims 10 to 25 wherein said further material comprises metal oxides, glass, glass-ceramics, SiOₓ, perovskite, ceramics, aluminum oxides, silicon carbide, boron nitride, carbon or zirconium oxides.

29. The process of any of claims 10 to 26 wherein said further material is obtained by polymerization of-one or more monomers.

30. The process of claim 29 wherein said further material is obtained by homo- or copolymerization of methacrylate, styrenesulfonate, 1,6-hexa-methylene diisocyanate(HDI), 4,4′-methylenebis-cyclohexyl diisocyanate(HMDI), 4,4′-methylenebis-(benzyl diisocyanate)(MDI), 1,4-butanediol, ethylenediamine, ethylene, styrene, butadiene, 1-butene, 2-butene, vinyl alcohol, acrylonitrile, methyl methacrylate, vinyl chloride, fluorinated ethylenes and/or terephthalate.

31. The process of at least one of claims 10 to 30 wherein said degrading of said degradable material is effected thermally, chemically, biologically, radiation-inducedly, photochemically, using plasma, ultrasound, microwaves or extraction with a solvent.

32. The use of said oriented hollow fiber web of at least one of claims 1 to 9 as a separation medium or storage medium for gases, liquids or particle suspensions.

33. The use of said oriented hollow fiber web of at least one of claims 1 to 9 in dialysis, as an artificial lung, protein store, controlled release or drug delivery system or in medical separation techniques.

34. The use of said oriented hollow fiber web of at least one of claims 1 to 9 as a sensor constituent, as a microreactor or in micro-electronics as a wire, cable or capacitor.

35. The use of said oriented hollow fiber web of at least one of claims 1 to 9 in superlightweight building construction technology, as a composite material, as a filler, as a mechanical reinforcement, as a heat insulator or in the clothing industry.

36. The use of said oriented hollow fiber web of at least one of claims 1 to 9 in fuel cells, batteries or electrochemical reactions.

37. The use of said oriented hollow fiber web of at least one of claims 1 to 9 in capillary electrophoresis, scanning probe microscopy or catalytic systems.

38. The use of said oriented hollow fiber web of at least one of claims 1 to 9 as a dielectric.

39. The use of said oriented hollow fiber web of at least one of claims 1 to 9 as an interlayer dielectric in chip manufacture.

40. The use of said oriented hollow fiber web of at least one of claims 1 to 9 for producing cross-laid webs.
